(19) United States
(12) Patent Application Publication
(10) Pub. No.: US 2025/0097811 A1
(43) Pub. Date: Mar. 20, 2025

(54) SYSTEMS AND METHODS FOR REDUCING SYSTEM INFORMATION ACQUISITION DURING CELL RESELECTION IN A NON-TERRESTRIAL NETWORK

(71) Applicant: Telefonaktiebolaget LM Ericsson (PUBL), Stockholm (SE)

(72) Inventors: Emre Yavuz, STOCKHOLM (SE); Xingqin Lin, SAN JOSÈ, CA (US); Johan Rune, LIDINGÖ (SE); Talha Khan, SANTA CLARA, CA (US); Jonas Sedin, BRENTFORD Greater London (GB)

(21) Appl. No.: 18/701,999

(22) PCT Filed: Oct. 20, 2022
(86) PCT No.: PCT/IB2022/060109

§ 371 Date: Apr. 17, 2024

Related U.S. Application Data
(60) Provisional application No. 63/270,530, filed on Oct. 21, 2021.

(51) Int. Cl. H04W 36/36; H04W 48/10

(52) U.S. Cl. CPC H04W 36/36; H04W 48/10

(57) ABSTRACT

A method (700) performed by a UE (112) includes receiving (702), from a first cell of a NTN, a set of one or more system information parameters. The UE receives, from a second cell of the NTN, an indication to use, for the second cell, the set of one or more system information parameters received from the first cell.

### TECHNICAL FIELD

The present disclosure relates, in general, to wireless communications and, more particularly, systems and methods for systems and methods for reducing System Information (SI) acquisition during cell reselection in a Non-Terrestrial Network (NTN).

### BACKGROUND

The 3rd Generation Partnership Project (3GPP) unites telecommunications standard development organizations and provides an environment to produce the Technical Reports (TRs) and Technical Specifications (TSs) that define 3GPP technologies. How to specify technologies to cover use cases for Machine-to-Machine (M2M) and/or Internet-of-Things (IoT) has been discussed extensively in 3GPP in the last couple of years. In Release 13, enhancements to support Machine-Type Communications (MTC) were specified introducing new user equipment (UE) categories M1 (Cat-M1) and NB1 (Cat-NB1) to support reduced maximum bandwidth of up to 6 physical resource blocks (PRBs) in an enhanced MTC (eMTC) work item and narrowband (NB) carrier in an Narrowband-IoT (NB-IoT) work item specifying a new radio interface, respectively.

There are multiple differences between “legacy” procedures and channels defined for long term evolution (LTE) and the procedures and channels defined for eMTC or NB-IoT. Some important differences include a new physical downlink control channel, i.e., MTC Physical Downlink Control Channel (MPDCCH) used in eMTC and Narrowband Physical Downlink Control Channel (NPDCCH) used in NB-IoT. 3GPP Release 12 initiated the work on eMTC, also often referred to as LTE-M, and specified the first low-complexity UE category 0 (Cat-0). Cat-0 supports a reduced peak data rate of 1 Mbps, single antenna and half duplex frequency division duplex (HD FDD) operation.

In Release 13, the work accelerated with the introduction of the Cat-M1 UE category. It supports a further reduced complexity, and coverage enhanced (CE) operation. The additional cost reduction came from a reduced transmission and reception bandwidth of 1.08 MHz, equivalent to six 180 kHz physical resource blocks (PRBs). The introduction of a lower UE power class of 20 dBm, in addition to the 23 dBm power class, further facilitates a lower UE complexity. Because of the reduction in bandwidth, a new narrowband physical downlink control channel, the MDPCCH, was introduced as a substitute for the wideband legacy physical downlink control channel (PDCCH) and the Enhanced PDCCH (EPDCCH). The Cat-M1 UEs monitor MPDCCH in a NB, which is defined by 6 adjacent PRBs.

eMTC supports a maximum coupling loss (MCL) that is 20 dB larger than the normal MCL of LTE. This is achieved mainly through time repetition and a relaxed acquisition time of the physical channels and signals. The primary and secondary synchronization signals (PSS and SSS) are fully reused from LTE and extended coverage is achieved by means of increased acquisition time.

For the physical broadcast channel (PBCH), the MPDCCH, the physical uplink control channel (PUCCH) and the data channels, that is, the physical uplink shared channel (PUSCH) and physical downlink shared channel (PDSCH), the desired coverage enhancement is achieved through so-called time repetition of a transmission block.

In LTE Releases 14 and 15, eMTC was further enhanced to support a more diversified set of applications and services. Anew UE category Cat-M2 was specified. The performance of eMTC Release 15 meets the IMT-2020 5G requirements for the massive IoT use case.

The work in 3GPP on eMTC continued in Release 16 and has further evolved in Release 17.

### NB-IoT

At the 3GPP RAN #70 meeting, a new Release 13 work item named NB-IoT was approved. The objective of the new IoT related work items approved for Release 13 was to specify a radio access for cellular IoT that addresses improved indoor coverage, support for massive number of low throughput devices, not sensitive to delay, ultra-low device cost, low device power consumption and (optimized) network architecture.

NB-IoT can be described as a narrowband version of LTE. Similar to eMTC, NB-IoT makes use of increased acquisition times and time repetitions to extend the system coverage. The repetitions can be seen as a third level of retransmissions added at the physical layer as a complement to those at Medium Access Control (MAC) Hybrid Automatic Repeat Request (HARQ) and Radio Link Control (RLC) Automatic Repeat Request (ARQ). A NB-IoT downlink carrier is defined by 12 orthogonal frequency-division multiplexing (OFDM) sub-carriers, each of 15 kHz, giving a total baseband bandwidth of 180 kHz. When multiple carriers are configured, several 180 kHz carriers can be used such as, for example, for increasing the system capacity, inter-cell interference coordination, load balancing, etc. This design gives NB-IoT a high deployment flexibility.

NB-IoT supports 3 different deployment scenarios or mode of operations:
‘Stand-alone operation’ utilizing for example the spectrum currently being used by Global System for Mobile Communication EDGE Radio Access Network (GERAN) systems as a replacement of one or more Global System for Mobile Communication (GSM) carriers. In principle, it operates on any carrier frequency which is neither within the carrier of another system nor within the guard band of another system's operating carrier. The other system can be another NB-IoT operation or any other radio access technology (RAT), e.g., LTE.
‘Guard band operation’ utilizing the unused resource blocks within an LTE carrier's guard-band. The term guard band may also be interchangeably called guard bandwidth. As an example, in case of LTE bandwidth (BW) of 20 MHz (i.e., Bw1=20 MHz or 100 Resource Blocks (RBs)), the guard band operation of NB-IoT can place anywhere outside the central 18 MHz but within 20 MHz LTE BW.
‘In-band operation’ utilizing resource blocks within a normal LTE carrier. The in-band operation may also interchangeably be called in-bandwidth operation. More generally the operation of one Radio Access Technology (RAT) within the BW of another RAT is also called as in-band operation. As an example, in an LTE BW of 50 RBs (i.e., Bw1=10 MHz or 50 RBs), NB-IoT operation over one RB within the 50 RBs is called in-band operation.

### Anchor Carrier and Non-Anchor Carrier in NB-IoT

In NB-IoT, anchor and non-anchor carriers are defined. In anchor carrier, the UE assumes that anchor specific signals, including Narrowband Primary Synchronization Sequence (NPSS), Narrowband Secondary Synchronization Sequence (NSSS), Narrowband Physical Broadcast Channel (NPBCH), and/or System Information Block-NB (SIB-NB), are transmitted on downlink. In non-anchor carrier, the UE does not assume that NPSS, NSSS, NPBCH, and/or SIB-NB are transmitted on downlink (DL). The anchor carrier is transmitted on at least subframes #0, #4, #5 in every frame and subframe #9 in every other frame. Additional DL subframes in a frame can also be configured on anchor carrier by means of a DL bit map. The anchor carriers transmitting NPBCH/SIB-NB contains also narrowband reference signals (NRS).

The non-anchor carrier contains NRS during certain occasions and UE specific signals such as NPDCCH and NPDSCH. NRS, NPDCCH and NPDSCH are also transmitted on anchor carrier. The resources for non-anchor carrier are configured by the network node. The non-anchor carrier can be transmitted in any subframe as indicated by a DL bit map. For example, the network node (e.g., eNodeB (eNB)) signals a DL bit map of DL subframes using radio resource control (RRC) message (DL-Bitmap-NB) which are configured as non-anchor carrier. The anchor carrier and/or non-anchor carrier may typically be operated by the same network node, for example, by the serving cell. But the anchor carrier and/or non-anchor carrier may also be operated by different network nodes.

### Discontinuous Reception Mechanism

In order for the UE to not be awake all the time when in idle or connected mode to decode data such as, for example, paging messages and system information (SI) update notification or user data that can be transmitted in the DL, a Discontinuous Reception (DRX) mechanism is introduced. The UE does not need to monitor for PDCCH transmission in every subframe in order to check if there is downlink data available with this mechanism. The main motivation is to avoid UE power consumption and thus extend UE battery lifetime.

The eNB configures DRX with a set of DRX parameters which are configured based on the characteristics of the traffic. When DRX is enabled, there will be a delay when receiving the data in the downlink in case the UE is not active so it is important to configure the DRX parameters properly such that the packet delay is minimized while maximum power can be saved.

During DRX mode, UE listens to the downlink when it is in active state, whereas in sleep state the UE does not monitor for receiving PDCCH transmissions, if they exist, from the eNB.

### Non-Terrestrial Networks

In 3GPP Release 15, the first release of the 5G system (5GS) was specified. This is a new generation radio access technology intended to serve use cases such as enhanced mobile broadband (eMBB), ultra-reliable and low latency communication (URLLC) and massive machine type communication (mMTC). 5G includes the New Radio (NR) access stratum interface and the 5G Core Network (5GC). The NR physical and higher layers are reusing parts of the LTE specification. Additional components are introduced when motivated by the new use cases.

In Release 15, 3GPP also started the work to prepare NR for operation in a Non-Terrestrial Network (NTN). The work was performed within the study item “NR to support Non-Terrestrial Networks” and resulted in 3GPP TR 38.811. In Release 16, the work to prepare NR for operation in an NTN network continues with the study item “Solutions for NR to support Non-Terrestrial Network.” In parallel, the interest to adapt LTE for operation in NTN is growing. As a consequence, 3GPP has agreed to introduce support for NTN in both LTE and NR in Release

### Satellite Communications

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 1 illustrates an example architecture of a satellite network with bent pipe transponders.

The NTN beam may in comparison to the beams observed in a terrestrial network be very wide and cover an area outside of the area defined by the served cell. Beam covering adjacent cells will overlap and cause significant levels of intercell interference. To overcome the large levels of interference a typical approach is to configure different cells with different carrier frequencies and polarization modes.

In a LEO NTN, the satellites are moving with a very high velocity. This leads to a Doppler shift of the carrier frequency on the service link of up to 24 ppm for a LEO satellite at 600 km altitude. The Doppler shift is also time variant due to the satellite motion over the sky. The Doppler shift may vary with up to 0.27 ppm/s for a LEO 600 km satellite. The Doppler shift will impact, i.e., increase or decrease, the frequency received on the service link compared to the transmitted frequency. For GEO NTN, the satellites may move in an orbit inclined relative to the plane of the equator. The inclination introduces a periodic movement of the satellite relative earth which introduces a predictable, and daily periodically repeating Doppler shift of the carrier frequency. FIG. 2 illustrates an example of the diumal Doppler shift of the forward service link observed for a GEO satellite operating from an inclined orbit.

Throughout this disclosure, the terms beam and cell are used interchangeably, unless explicitly noted otherwise. The disclosure is focused on NTN in the context of IoT, but the methods proposed apply to any wireless network dominated by line-of-sight conditions.

### Ephemeris Data

According to 3GPP TR 38.821, ephemeris data should be provided to the UE such as, for example, to assist with pointing a directional antenna (or an antenna beam) towards the satellite. A UE knowing its own position, which may be in thanks to Global Navigation Satellite System (GNSS) support, may also use the ephemeris data to calculate correct Timing Advance (TA) and Doppler shift. The contents of the ephemeris data and the procedures on how to provide and update such data have not yet been studied in detail.

A satellite orbit can be fully described using 6 parameters. Exactly which set of parameters is used can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). FIG. 3 illustrates the set of these parameters, which may also be referred to as Orbital Elements. In FIG. 3, the periapsis refers to a point where the orbit is nearest to Earth, the first point of Aries refers to the direction towards the sun at the March equinox, and the ascending node refers to the point where the orbit passes upwards through the equatorial plane.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes called orbital state vectors. They can be derived from the orbital elements and vice versa since the information they contain is equivalent. All these formulations (and many others) are possible choices for the format of ephemeris data to be used in NTN.

It is important that a UE can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another aspect discussed during the study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

So, while it seems possible to provide the satellite position with the required accuracy, care needs to be taken to meet these requirements such as, for example, when choosing the ephemeris data format, or the orbital model to be used for the orbital propagation.

Ephemeris data consists of at least 5 parameters describing the shape and position in space of the satellite orbit. It also comes with a timestamp, which is the time when the other parameters describing the orbit ellipse were obtained. The position of the satellite at any given time in the nearer future can be predicted from this data using orbital mechanics. The accuracy of this prediction will however degrade as one projects further and further into the future. The validity time of a certain set of parameters depends on many factors like the type and altitude of the orbit, but also the desired accuracy, and ranges from the scale of a few days to a few years.

There currently exist certain challenge(s), however. The following can be considered challenges that need to be addressed when evolving cellular IoT technologies, such as eMTC and NB-IoT, to support NTN:
Moving satellites (resulting in moving or switching cells): The default assumption in terrestrial network design, e.g., NR or LTE, is that cells are stationary. This is not the case in NTN, especially when LEO satellites are considered. A LEO satellite may be visible to a UE on the ground only for a few seconds or minutes. There are two different options for LEO deployment. The beam/cell coverage is fixed with respect to a geographical location with earth-fixed beams, i.e., steerable beams from satellites ensure that a certain beam covers the same geographical area even as the satellite moves in relation to the surface of the earth. On the other hand, with moving beams a LEO satellite has fixed antenna pointing direction in relation to the earth's surface, e.g., perpendicular to the earth's surface, and thus cell/beam coverage sweeps the earth as the satellite moves. In that case, the spotbeam, which is serving the UE, may switch every few seconds.
Long propagation delays: The propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.
Large Doppler shifts: The movements of the spaceborne or airborne platforms deployed in NTN may result in large Doppler shifts. For example, a LEO satellite at the height of 600 km can lead to a time-varying Doppler shift as large as 24 ppm.

Cell reselection is a mechanism for mobility in RRC Idle and RRC Inactive states. The UE finds the best cell to camp on based on some criteria such as priority, ranking or cell accessibility. Similar to initial cell search, UE searches for synchronization signal (SS) blocks to find the best cell to camp on. When the received power of the serving cell SS block becomes less than a threshold and a neighboring SS block exceeds the received power of serving cell SS block by a certain configured threshold, the UE acquires system information block 1 (SIB1) of the new cell to determine whether it is allowed to camp on that particular cell. Once it is confirmed that it is allowed to camp on the cell, the UE acquires the rest of the SI upon cell reselection.

Typically, an IoT device finds itself in the same cell when it wakes up to monitor for paging especially considering that it is either stationary or it has low mobility. However, in a NTN, especially when serving satellite is categorized as LEO or MEO, it is very likely that the UE wakes up in a cell other than the serving cell when it wakes up to monitor for paging. This means that the UE would need to acquire a new set of SI every time it wakes up if the paging DRX cycle is, for example, larger than ˜10 seconds because the cell switches would be quite frequent due to moving satellites. However, the frequent acquisition of SI has a considerable impact on UE power consumption and, thus, battery lifetimes.

### SUMMARY

Certain aspects of the disclosure and their embodiments may provide solutions to these or other challenges. For example, according to certain embodiments, methods and systems are disclosed that avoid or limit the acquisition of SI during cell selection in a NTN when the serving satellite is categorized as LEO or MEO.

According to certain embodiments, a method by a UE includes receiving, from a first cell of a NTN, a set of one or more system information parameters and receiving, from a second cell of the NTN, an indication to use, for the second cell, the set of one or more system information parameters received from the first cell.

According to certain embodiments, a UE includes processing circuitry configured to receive, from a first cell of a NTN, a set of one or more system information parameters and receive, from a second cell of the NTN, an indication to use, for the second cell, the set of one or more system information parameters received from the first cell.

According to certain embodiments, a method by a network node associated with a cell of a NTN includes sending, to a UE, an indication to use, in the cell, a set of one or more system information parameters previously received by the UE for use in another cell.

According to certain embodiments, a network node includes processing circuitry configured to send, to a UE, an indication to use, in the cell, a set of one or more system information parameters previously received by the UE for use in another cell.

Certain embodiments may provide one or more of the following technical advantage(s). For example, certain embodiments may provide a technical advantage of helping the UE to avoid or limit the acquisition of SI during cell reselection in an NTN so that the impact on UE power consumption can be reduced and battery lifetime prolonged.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

FIG. 2 illustrates an example of the diurnal Doppler shift of the forward service link observed for a GEO satellite operating from an inclined orbit;

FIG. 3 illustrates the set of these parameters, which may also be referred to as Orbital Elements;

FIG. 4 illustrates an example of a method 40 performed by a wireless device (such as a user equipment 112 or 200, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates an example method by a UE, according to certain embodiments; and

FIG. 12 illustrates an example method by a network node, according to certain embodiments.

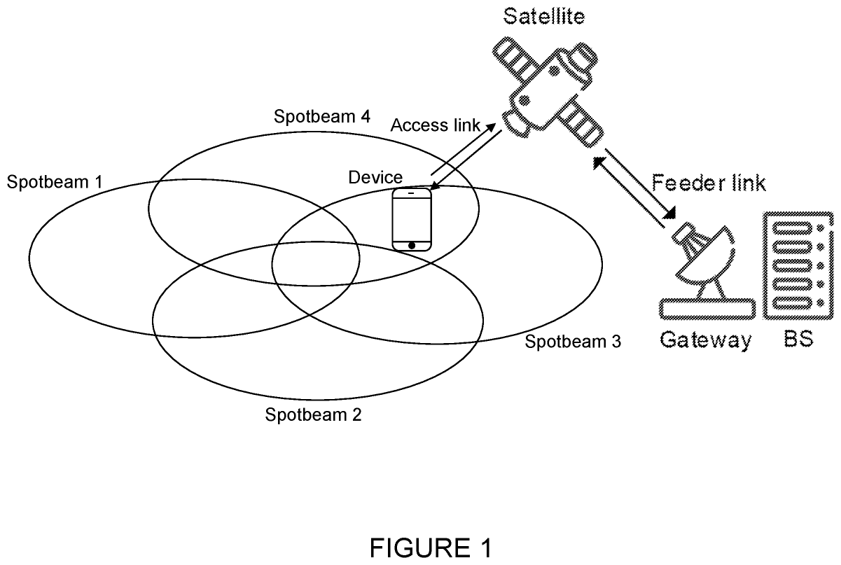

### DETAILED DESCRIPTION

Some of the embodiments contemplated herein will now be described more fully with reference to the accompanying drawings. Embodiments are provided by way of example to convey the scope of the subject matter to those skilled in the art.

Certain embodiments outlined below are described mainly in terms of NTNs based on LTE technology, including IoT. The embodiments are equally applicable in an NTN based on NR technology, including IoT.

Certain embodiments use the term “network” to refer to a network node, which may be an eNB in, for example, an LTE-based NTN or a gNB in, for example, an NR-based NTN or any other base station or access point in another type of network. Thus, the term “network” or “network node” may refer to any network node with the ability to directly or indirectly communicate with a UE.

The terms “idle mode”, “RRC IDLE state”, “inactive mode”, and “RRC INACTIVE” are used interchangeably herein.

Certain embodiments disclosed herein are described as targeting IoT UEs that do not have very delay-sensitive traffic, i.e., some additional delay prior to uplink (UL) data transmissions is acceptable. The goal of certain embodiments is to reduce the effort the UE has to make (e.g., in terms of energy consumption) to receive SI. For example, in an NTN, when a serving satellite is categorized as LEO or MEO, it is very likely that the UE will be located in a cell other than the serving cell when it wakes up to monitor for paging. Accordingly, certain embodiments propose methods, systems, techniques, and/or mechanisms that avoid the frequent acquisition of SI, considering its impact on UE power consumption and battery lifetime. Specifically, certain embodiments avoid or limit the acquisition of SI during cell selection in a NTN when serving satellite is categorized as LEO or MEO. For example, in particular embodiments, a UE knows at least part of the SI provided in a cell that the UE is not camping on, so that the UE can omit receiving this part of the SI if it reselects to the concerned cell.

Certain embodiments may distinguish essential SI from non-essential (or less essential)SI. As used herein, the term “essential SI” is refers to the part of the SI that a UE needs to camp on a cell, including (among other information) system information configuring parameters related to network access in the cell, such as random access channel (RACH) configuration. However, in the context of certain embodiments described herein, “essential SI” refers to information provided as part of broadcasted SI that is required by the UE to camp in a cell and check whether there is a need for cell (re)selection. Essential SI does not include SI that is strictly related to configuration of network access related mechanisms (such as RACH configuration), since it is not essential for the UE to know this information until the UE intends to trigger random access to establish a RRC connection. Such a connection establishment attempt can be due to pending traffic in the uplink (UL), tracking area update (periodical or tracking area change), etc. With the assumption that the UE has delay-insensitive traffic, the UE can tolerate the additional access delay of having to acquire the network access related SI when the need for it is triggered (by pending UL traffic, e.g., UL data arriving in an UL transmission buffer in the UE).

With this definition, the essential SI can be composed of the following listed parameters or any possible combination of these parameters:

From SIB1 or SIB1BR:
bandwithReducedAccessRelatedInfo
campingAllowedInCE
categoryOAllowed
cellAccessRelatedInfoList
cellAccessRelatedInfoList-5GC
cellBarred, cellBarred-CRS
cellBarred-5GC, cellBarred-5GC-CRS
cellReservedForOperatorUse, cellReservedForOperatorUse-CRS
cellSelectionInfoCE
cellSelectionInfoCE1
eDRX-Allowed
eDRX-Allowed-5GC
freqHoppingParametersDL
hyperSFN
intraFreqReselection
q-QualMin
q-QualMinRSRQ-OnAllSymbols
q-QualMinOffset
q-QualMinWB
q-RxLevMinOffset
si-HoppingConfigCommon
si-ValidityTime
startSymbolBR
systemInfoValueTagList
systemInfoValueTagSI
systemInfoValueTag

From SIB2:
idleModeMeasurements
idleModeMeasurementsNR

From SIB3:
allowedMeasBandwidth
altCellReselectionPriority
altCellReselectionSubPriority
cellSelectionInfoCE
cellSelectionInfoCE1
cellReselectionInfoCommon
cellReselectionServingFreqInfo
intraFreqcellReselectionInfo
redistrOnPagingOnly
q-Hyst
q-HystSF
q-QualMin
q-QualMinRSRQ-OnAllSymbols
q-QualMinWB
q-RxLevMin
s-IntraSearch
s-IntraSearchP
s-IntraSearchQ
s-NonIntraSearch
s-NonIntraSearchP
s-NonIntraSearchQ
s-SearchDeltaP
threshServingLow
threshServingLowQ
t-ReselectionEUTRA
t-ReselectionEUTRA-SF

From SIB4:
intraFreqBlackCellList
intraFreqNeighCellList

From SIB5:
altCellReselectionPriority
altCellReselectionSubPriority
cellSelectionInfoCE
cellSelectionInfoCE1
interFreqBlackCellList
interFreqCarrierFreqList
interFreqCarrierFreqListExt
interFreqNeighCellList
measIdleConfigSIB
measIdleConfigSIB-NR
multiBandInfoList
q-OffsetCell
q-OffsetFreq
q-QualMin
q-QualMinRSRQ-OnAllSymbols
q-QualMinWB
redistributionFactorFreq
redistributionFactorCell
reducedMeasPerformance
threshX-High
threshX-HighQ
threshX-Low
threshX-LowQ
t-ReselectionEUTRA
t-ReselectionEUTRA-SF
   It is recognized that the above list of parameters is provided for purposes of example only and is non-limiting. Other embodiments may include other parameters (e.g., in addition to and/or as an alternative to the listed parameters).

According to certain embodiments, the network indicates in the Master Information block (MIB) that a same configuration is provided at least for the essential SI for all cells in the tracking area. This indication can be in the form of a Tracking Area Code or Tracking Area Code 5GC in the MIB. Specifically, if provided in the MIB, the Tracking Area Code or Tracking Area Code 5GC implicitly indicates that the same configuration is provided at least for the essential SI for all cells in this tracking area so that there is no need for the UE to acquire SI unless the UE attempts to establish a connection to the network.

Optionally, a Hyper subframe number (SFN) may also be provided in MIB in addition to the tracking area code. However, if only a Tracking Area Code is provided and no hyper SFN is provided, the UE either assumes that it can keep track of the Hyper-Subframe Number (H-SFN) cycles while it is asleep, e.g., UE's clock does not deviate more than half of an SFN cycle, i.e., half of 10.24 sec., or the UE acquires at least SIB1/SIB1-BR to update and/or confirm the H-SFN.

Tracking area code is used to identify a tracking area within the scope of a Public Land Management Network (PLMN). The related information element is specified as follows:

TrackingAreaCode information element

| -- ASN1START | |
|---|---|
| TrackingAreaCode ::= | BIT STRING (SIZE (16)) |
| TrackingAreaCode-5GC-r15 ::= | BIT STRING (SIZE (24)) |

-- ASN1STOP

The master information block (for LTE-M) is specified as follows:

MasterInformationBlock

| -- ASN1START | |
|---|---|
| MasterInformationBlock ::= | SEQUENCE { |
| dl-Bandwidth | ENUMERATED { |
| | n6, n15, n25, n50, n75, |
| n100}, | |
| phich-Config | PHICH-Config, |
| systemFrameNumber | BIT STRING (SIZE (8)), |
| schedulingInfoSIB1-BR-r13 | INTEGER (0..31), |
| systemInfoUnchanged-BR-r15 | BOOLEAN, |
| spare | BIT STRING (SIZE (4)) |

}
-- ASN1STOP

It may be noted that only 4 bits and 9 bits are available as spare for LTE-M and NB-IoT, respectively, while the size of the Tracking Area Code is 16 bits and the size of the Tracking Area Code 5GC is 24 bits. Accordingly, in a particular embodiment, only the last 4 or 9 bits of the tracking area code can be broadcast as part of the MIB. Alternatively, in another particular embodiment, only the last 3, 2 or 1 bit(s) (or 8, 7, . . . or 3 bits for NB-IoT since the 2 least significant bits of HSFN is already provided in the MIB for NB-IoT) of the tracking area code can be broadcast. As another alternative, in yet another particular embodiment, the rest of the spare bits can be used to broadcast the last 3, 2, or 1 bit (or 8, 7, . . . or 1 bit for NB-IoT) of hyper SFN, which is 10 bits long.

In still another particular embodiment, a new SIB is introduced which is scheduled with the information provided with the parameter schedulingInfoSIB1-BR-r13 using the reserved values provided in 3GPP TS 36.213 clause 7.1.6. Note that the scheduling information for the new SIB would be provided along with the scheduling information for SIB1-BR in this case, e.g., value 20 provides scheduling information both for SIB1-BR and the new SIB.

For a Bandwidth reduced Low complexity (BL)/Coverage Enhancement (CE) UE, the resource allocation for PDSCH carrying SystemInformationBlockType1-BR and SI messages is a set of six contiguously allocated localized virtual resource blocks within a narrowband. The number of repetitions for the PDSCH carrying SystemInformationBlockType1-BR is determined based on the parameter schedulingInfoSIB1-BR, which is configured by higher-layers and provided below in Table 1, which corresponds to Table 7.1.6-1 of 3GPP TS 36.213. If the value of the parameter schedulingInfoSIB1-BR configured by higher-layers is set to 0, UE assumes that SystemInformationBlockType1-BR is not transmitted.

TABLE 1
Number of repetitions for PDSCH
carrying SystemInformationBlockType1-BR
for BL/CE UE.

| Value of schedulingInfoSIB1-BR | Number of PDSCH repetitions |
|---|---|
| 0 | N/A |
| 1 | 4 |
| 2 | 8 |
| 3 | 16 |
| 4 | 4 |
| 5 | 8 |
| 6 | 16 |
| 7 | 4 |
| 8 | 8 |
| 9 | 16 |
| 10 | 4 |
| 11 | 8 |
| 12 | 16 |
| 13 | 4 |
| 14 | 8 |
| 15 | 16 |
| 16 | 4 |
| 17 | 8 |
| 18 | 16 |
| 19-31 | Reserved |

In another particular embodiment, the new SIB is scheduled using one or more bits from the 4 spare bits in the MIB. The field may be named as schedulingInfoSIBX in a particular embodiment. Table 2 provides a non-limiting example for how the new SIB may be scheduled for BL/CE UE. Table 2 may be used together with Table 6.4.1-1 and Table 6.4.1-2, as provided in 3GPP TS 36.211, for determining the time domain scheduling for the new SIB. Table 2 may also be used together with Table 7.1.7.2.7-1 of 3GPP TS 36.213 for determining the Transport Block Size for the new SIB.

TABLE 2
Number of repetitions for PDSCH carrying
SystemInformationBlockTypeX for BL/CE UE.

| Value of schedulingInfoSIB1-BR | Number of PDSCH repetitions |
|---|---|
| 0 | N/A |
| 1 | 4 |
| 2 | 8 |
| 3 | 16 |
| 4 | 4 |
| 5 | 8 |
| 6 | 16 |
| 7 | 4 |
| 8 | 8 |
| 9 | 16 |
| 10 | 4 |
| 11 | 8 |
| 12 | 16 |
| 13 | 4 |
| 14 | 8 |
| 15 | 16 |

In another particular embodiment, the PHICH-Config of the MasterInformationBlock is reused and is repurposed to convey information about the tracking area or H-SFN. The reason why the PHICH-Config can be reused is because the information therein is disregarded by the LTE-M UEs. This can either be accomplished by introducing a note that a BL UE shall regard the PHICH-Config as either a reduced Tracking Area Code or reduced H-SFN or a combination of the above. In a particular embodiment, this may only be applicable for LTE-M UEs for standalone deployment since otherwise PHICH-Config needs to be broadcast as part of MIB in a serving cell where LTE UEs, i.e., Cat 0, Cat 4 and higher, are served by the network.

MasterInformationBlock field descriptions

. . .
phich-Config
Specifies the PHICH configuration. If the UE is a
BL UE or UE in CE, it shall ignore this field.

In yet another particular embodiment, the scheduling information for the new SIB is coded in a combination of a reserved schedulingInfoSIB1-BR-r13 and a set of (1, 2, 3 or 4) spare bits. As one option, this combination indicates a Time Domain Resource Allocation (TDRA) table entry/row (optionally with a default frequency domain resource assignment). As another option, a reserved schedulingInfoSIB1-BR-r13 value could point out a TDRA table and the utilized spare bits point out an entry/row in this TDRA table (with a default frequency domain resource allocation). As yet another option, the utilized spare bits indicate a TDRA table while the schedulingInfoSIB1-BR-r13 value indicates an entry/row in this TDRA table.

In other particular embodiments, the combination of (reserved) schedulingInfoSIB1-BR-r13 value and set of (1, 2, 3 or 4) utilized spare bits indicate the frequency domain resource assignment, with a default time domain resource allocation.

In yet other particular embodiments, some of the available combinations of (reserved) schedulingInfoSIB1-BR-r13 values and utilized spare bits are used for the frequency domain resource assignment, while the rest of the available combinations of (reserved) schedulingInfoSIB1-BR-r13 values and utilized spare bits are used to indicate the time domain resource allocation (e.g., utilizing one or more TDRA table(s)). For instance, the reserved schedulingInfoSIB1-BR-r13 values could indicate the time domain resource allocation, while the utilized spare bit(s) indicate(s) the frequency domain resource assignment or vice versa.

In certain variants of the above embodiments, where reserved value(s) of schedulingInfoSIB1-BR-r13 and/or spare MIB bit(s) is/are used to indicate time and/or frequency resources in the time-frequency OFDM grid, the indicated resources are not used for transmission of a new SIB, but for transmission of a PDCCH that schedules (using DL scheduling assignment) transmission of anew SIB, which may contain some or all of the previously described information.

In other particular embodiments, the Tracking Area Code or Tracking Area Code 5GC in the above described embodiments is replaced with a system information area ID. This system information area ID would serve a similar purpose but would not be tied to tracking areas. Instead, a system information area is formed by the cells in which the same system information area ID is broadcast. This is similar to the system information area ID concept in 5G/NR. However, this concept can be modified by first reducing the number of possible values a system area ID can have (it consists of 24 bits in 5G/NR) so that it can be indicated by the reserved values of the schedulingInfoSIB1-BR-r13 or the set of (or a subset of) the spare bits or a combination of the reserved values of the schedulingInfoSIB1-BR-r13 and the set of (or a subset of) the spare bits. Such a reduction in the number of possible system information area ID values may mean that system information area IDs may have to be reused within the network. If reuse of system information area IDs is used for different system information areas in the network, a system information area has to be formed by contiguous cells. Cells belonging to different system information areas that reuse the same system information area ID have to be separated by at least one cell using another system information area ID or no system information area ID at all or, optionally, be separated by a space without network coverage.

In another particular embodiment, one of the spare bits in the MIB is used to indicate extension of the MIB, where the extension contains one or more of the Tracking Area Code, Tracking Area Code 5GC, system information area ID and the H-SFN. In this embodiment, the MIB extension has a location in the time-frequency resource grid that is fixed (e.g., in relation to the PSS, SSS and/or the MIB) according to standard specifications, just like the location in the time-frequency resource grid of the MIB is fixed in relation to the PSS/SSS as specified by standard specifications.

In another particular embodiment, the MIB extension's location in the time frequency grid is not fixed by standard specification. Instead, a PDCCH is fixed (as described above for the variant where the MIB extension's location was fixed), and this PDCCH is used to schedule (through DL scheduling assignment) the transmission of the MIB extension (i.e., the time-frequency resources used for transmission of the MIB extension). This method can also be applied with the 5G/NR MIB, which contains a single spare bit that can be used for this purpose. When applied to the 5G/NR MIB, there may be a specified search space that the UE is supposed to use to find a PDCCH that schedules, using DL scheduling assignment, the transmission of the MIB extension.

In yet another further particular embodiment, more than one spare bit is utilized to indicate the existence of the MIB extension, and the combination of these bits indicates one out of multiple (e.g., one out of four if two spare bits are utilized) specified locations of the MIB extension in the time-frequency resource grid such as, for example, in relation to the PSS, SSS and/or MIB). Alternatively, a combination of the utilized spare bits indicates one out of multiple (e.g., one out of four if two spare bits are utilized) specified locations of a PDCCH that is used to schedule (using DL scheduling assignment) the transmission of the MIB extension.

When more than one spare bit is utilized, a variation of the above embodiment can be that different utilized bits or combinations of utilized bit values indicates the particular information that is included in the MIB extension, e.g., which one(s) of the Tracking Area Code, Tracking Area Code 5GC, system information area ID and H-SFN that is/are included in the MIB extension. This may be combined with the embodiments where spare bits are utilized to indicate the location in the time-frequency grid of the MIB extension or a PDCCH, e.g., using a subset of the utilized bits to indicate the content of the MIB extension and using another subset to indicate the location in the time-frequency grid of the MIB extension or a PDCCH.

In all the above embodiments involving MIB extension, the MIB extension may be replaced by a new SIB (with the same content), in a particular embodiment. The new SIB, which may include, for example, SIBX or SIB1-NTN, would then be composed of the Tracking Area Code (or Tracking Area Code 5GC or system information area ID) and, optionally, hyper SFN. The new SIB may be specified in 3GPP TS 36.331 as follows (note that this is just an example):

| | |
|---|---|
| - | SystemInformationBlockTypeX |

```
  SystemInformationBlockTypeX contains information which is required by the UE to camp
  in a cell and check whether there is a need for cell (re)selection but not necessarily required
  for the UE to know unless the UE intends to trigger random access to establish a RRC
  connection.
```

| | Signalling radio bearer: N/A | |
|---|---|---|
| | RLC-SAP: TM | |
| | Logical channels: BCCH and BR-BCCH | |
| | Direction: E-UTRAN to UE | |
| | SystemInformationBlockTypeX message | |
| | -- ASN1START | |
| SystemInformationBlockTypeX ::= | | SEQUENCE { |
| | cellAccessRelatedInfo | SEQUENCE { |
| | trackingAreaCode | TrackingAreaCode, |
| | hyperSFN | BIT STRING (SIZE (10)) OPTIONAL -- |

Need OR
}
}
-- ASN1STOP

In another particular embodiment, SIBX may contain any of the parameters listed in the essential system information defined above as optional parameters. Thus, it may be up to the network to provide the parameters, if configured differently with respect to the other cells in the same tracking area.

Let us consider the case where multiple Tracking Area Codes are transmitted per cell. In one particular embodiment, the network includes information about only one TAC in the proposed MIB or MIB extension or SIBX even if there are multiple TACs transmitted per cell. In a first example, the network broadcasts a single TAC for a certain cell “TAC_1” at time t_1. The network additionally begins to broadcast a second TAC “TAC_2” for the same cell at a later time t_2. In the proposed MIB/MIB extension/SIBX, however, the network includes TAC_1.

In a second example, the network may decide which TAC to include in the proposed MIB/MIB extension/SIBX based on the estimated number of NTN devices in respective cells at a TA border which may benefit from the TAC information included in the MIB/MIB extension/SIBX. If the network estimates that the number of devices in idle mode in cell 1 belonging to TAC_1 is higher than that in cell 2 belonging to TAC_2, it includes TAC_1 in the MIB/MIB extension/SIBX when it is transmitting both TAC_1 and TAC_2 when crossing from TAC_1 into TAC_2.

In another particular embodiment, the network indicates in the MIB or MIB extension or SIBX whether the network is transmitting multiple TACs in a given cell or not. This can be indicated by using 1 of the spare bits in MIB or explicitly indicated in MIB extension or SIBX. In a first example, if the bit multiple_TAC_transmit=1 and the TAC in MIB is different than the UE's current TAC, the UE assumes that the TA has not changed and that the UE does not need to fetch SIB. If the bit multiple_TAC_transmit=0, and the TAC in MIB is different than the UE's current TAC, the UE assumes that the TA has changed.

In another particular embodiment, when multiple TACs are transmitted per cell, the network includes information about more than one TAC in the proposed MIB or MIB extension or SIBX. When at least one of the TACs transmitted in the MIB/MIB extension/SIB is the same as the UE's current TAC, then the idle mode UE need not acquire SIB for cell reselection. For example, when a network node in a cell transmits two TACs “TAC_1” and “TAC 2”, the network node includes both TACs in SIBX.

In another embodiment, Tracking Area Code is broadcast as part of layer 1 signaling or synchronization block.

In all the above embodiments involving the Tracking Area Code, it is recognized that the Tracking Area Code may be replaced by a Tracking Area Identifier. Similarly, in all the above embodiments involving the Tracking Area Code 5GC, it is recognized that the Tracking Area Code 5GC may be replaced by a Tracking Area Identifier 5GC. Moreover, in all embodiments involving a system information area ID, the system information area ID may be replaced by another identifier serving a similar purpose such as, for example, identifying an area in which system information or partial system information (e.g., a one or more SIB(s) or specific system information parameters) is valid or the same in all cells in the area.

It is recognized that certain embodiments may be implemented in the context of a technical standard, such as 3GPP TS 36.331 and/or another technical standard. It is further recognized that certain embodiments described above may be implemented in a wireless device (such as a UE), a network node (such as an eNB), or a satellite. Certain embodiments may be implemented in Internet-of-Things (IoT), machine-type communications (MTC) (such as LTE-M), or other suitable deployments.

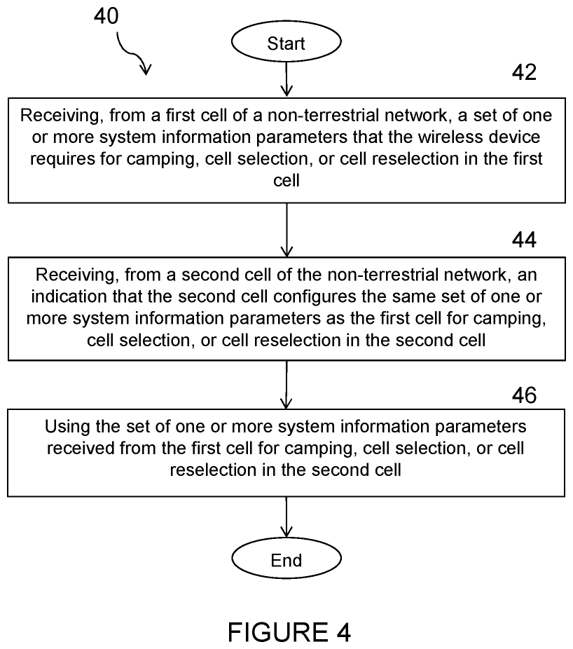

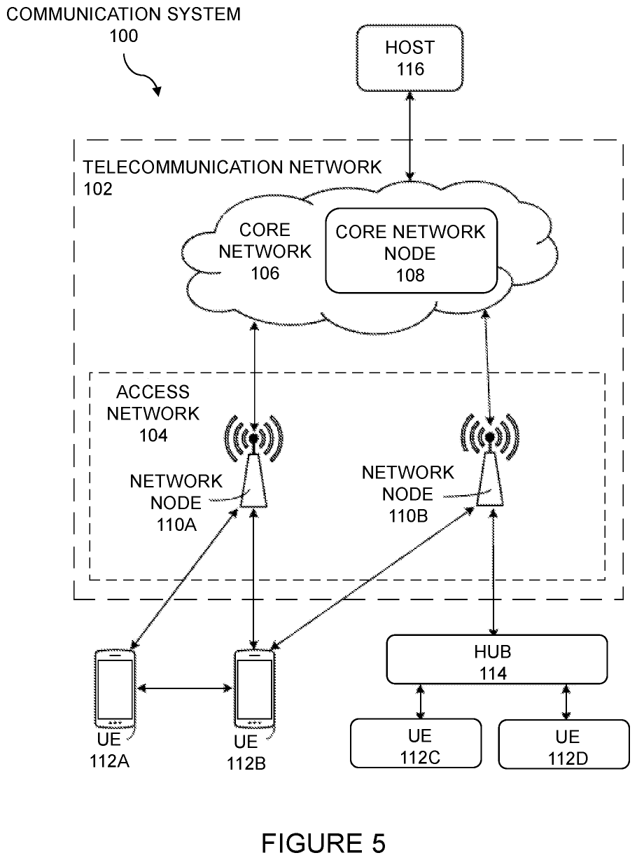

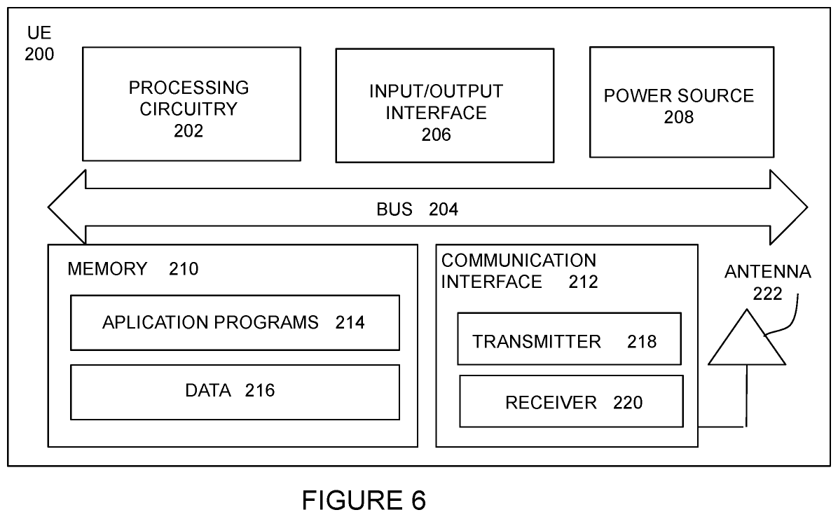

FIG. 4 illustrates an example of a method 40 performed by a wireless device (such as a user equipment 112 or 200, described below with respect to FIG. 5 and FIG. 6), according to certain embodiments. For example, the wireless device may comprise processing circuitry (such as processing circuitry 202) configured to perform the method. The method begins at step 42 with receiving, from a first cell of a non-terrestrial network, a set of one or more system information parameters that the wireless device requires for camping, cell selection, or cell reselection in the first cell. The method proceeds to step 44 with receiving, from a second cell of the non-terrestrial network, an indication that the second cell configures the same set of one or more system information parameters as the first cell for camping, cell selection, or cell reselection in the second cell. The method continues to step 36 with using the set of one or more system information parameters received from the first cell for camping, cell selection, or cell reselection in the second cell.

FIG. 5 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server. As a whole, the communication system 100 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

FIG. 6 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

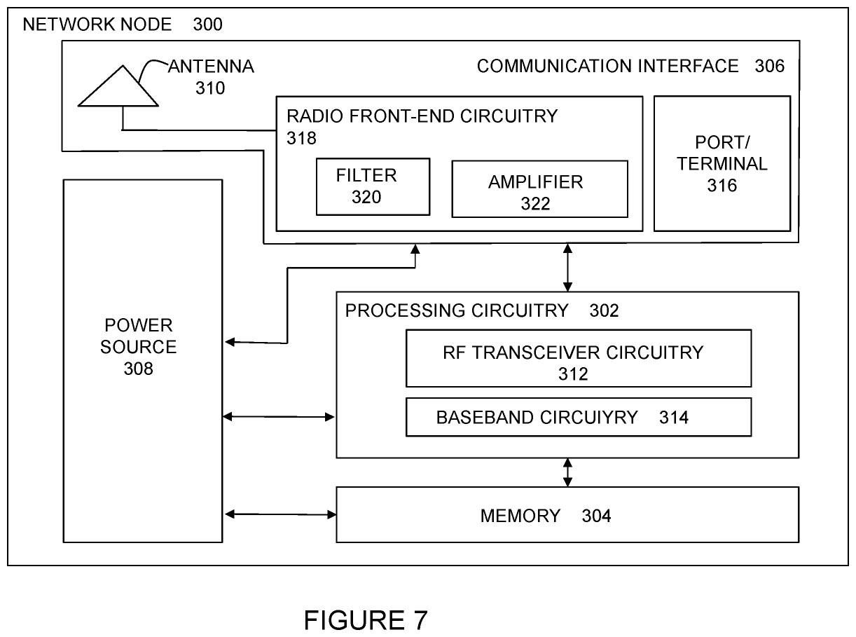

FIG. 7 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 7 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

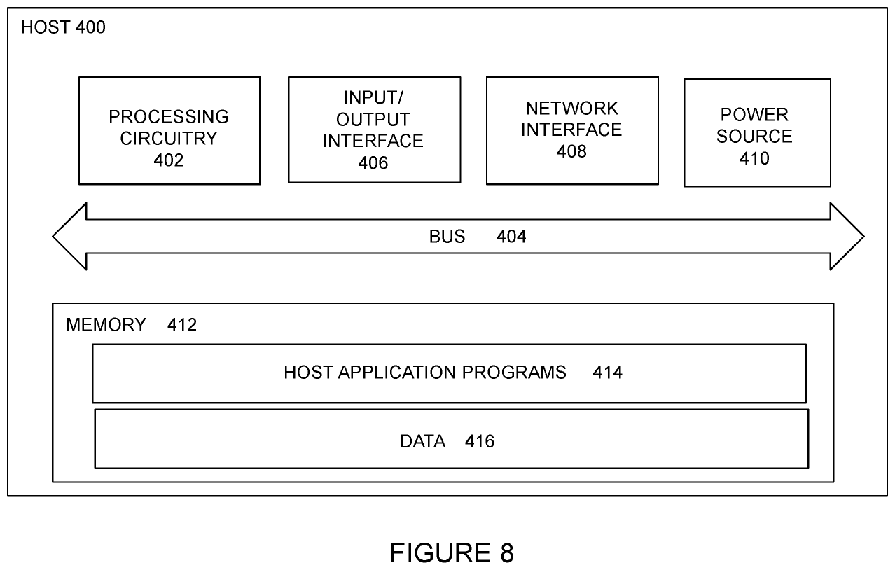

FIG. 8 is a block diagram of a host 400, which may be an embodiment of the host 116 of FIG. 5, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

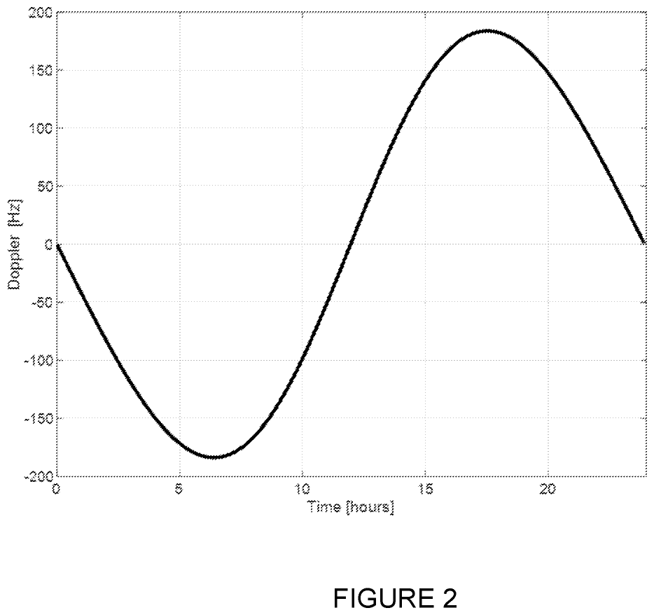

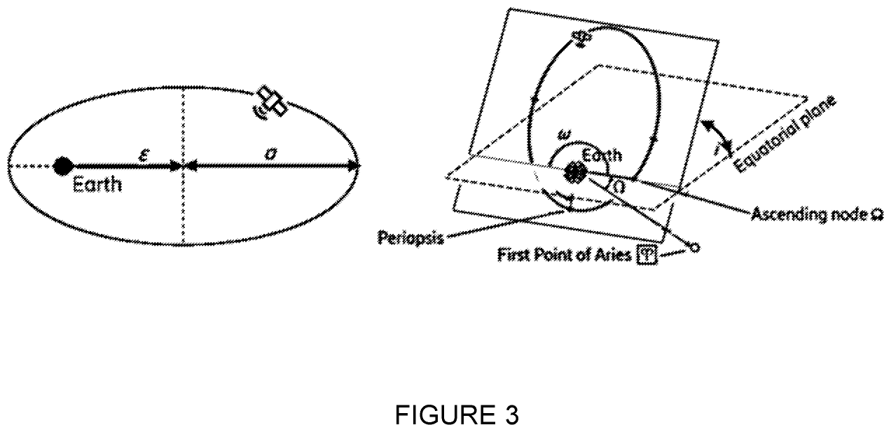

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

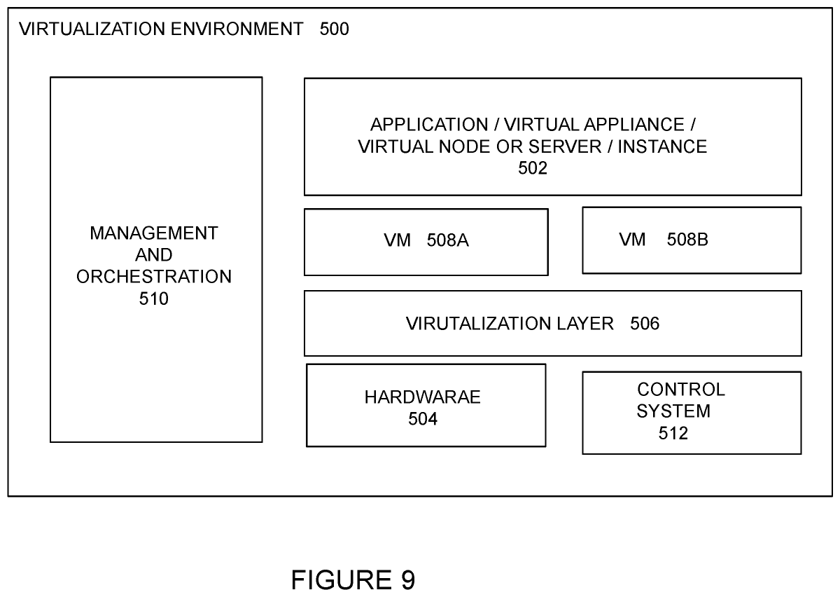

FIG. 9 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

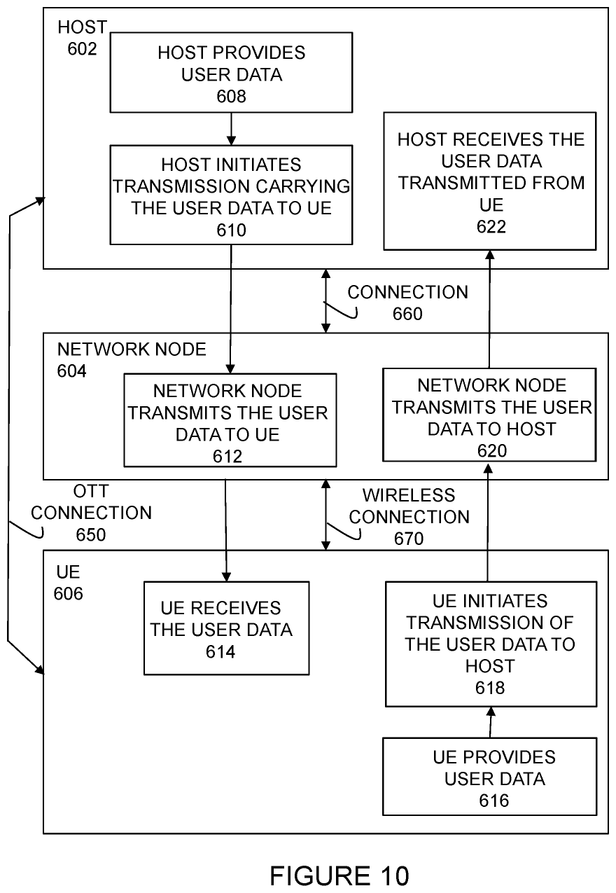

FIG. 10 shows a communication diagram of a host 602 communicating via a network node 604 with a UE 606 over a partially wireless connection in accordance with some embodiments. Example implementations, in accordance with various embodiments, of the UE (such as a UE 112a of FIG. 5 and/or UE 200 of FIG. 6), network node (such as network node 110a of FIG. 5 and/or network node 300 of FIG. 7), and host (such as host 116 of FIG. 5 and/or host 400 of FIG. 8) discussed in the preceding paragraphs will now be described with reference to FIG. 10.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 5) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the power consumption and thereby provide benefits such as extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

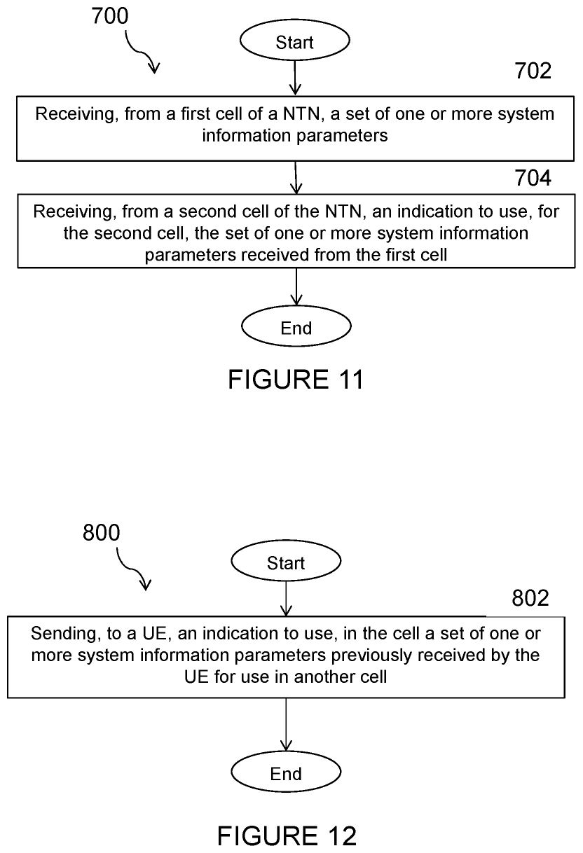

FIG. 11 illustrates a method 700 performed by a UE 112, 200, according to certain embodiments. The method begins at step 702 when the UE receives, from a first cell of a NTN, a set of one or more system information parameters. At step 704, the UE receives, from a second cell of the NTN, an indication to use, for the second cell, the set of one or more system information parameters received from the first cell.

In a particular embodiment, based on the indication, the UE 112, 200 determines not to acquire the set of one or more system information parameters from the second cell based on the UE having received the set of one or more system information parameters from the first cell.

In a particular embodiment, based on the indication, the UE 112, 200 uses at least one parameter within the set of system information parameters received from the first cell to determine whether the UE can camp in the second cell.

In a particular embodiment, the at least one parameter comprises a threshold, and when determining whether the UE can camp in the second cell, the UE 112, 200 determines that a signal strength in the second cell is greater than the threshold.

In a particular embodiment, based on the indication, the UE 112, 200 uses at least one parameter within the set of one or more system information parameters received from the first cell for performing an operation associated with at least one of camping, cell selection, and cell reselection in the second cell.

In a further particular embodiment, when performing the operation, the UE 112, 200 performs a cell selection or reselection to the second cell.

In a particular embodiment, the set of one more system information parameters comprises essential system information.

In a particular embodiment, the indication from the second cell is received in a broadcast message.

In a particular embodiment, the indication from the second cell is received in a MIB.

In a further particular embodiment, the MIB comprises a H-SFN indicator.

In a further particular embodiment, the UE 112, 200 determines that the MIB does not include a H-SFN indicator. Based on the MIB not including the H-SFN, the UE 112, 200 keeps track of H-SFN cycles at the wireless device and/or acquires system information to confirm or update the H-SFN cycles.

In a particular embodiment, the indication from the second cell includes a tracking area code of the second cell that is the same as a tracking area code of the first cell.

In a particular embodiment, the indication from the second cell includes a system information area identifier of the second cell that is the same as a system information area identifier of the first cell.

In a further particular embodiment, the system information area identifier of the second cell is received in scheduling information associated with a SIB.

In a particular embodiment, the UE 112, 200 receives, from the second cell, a second set of one or more system information parameters that the UE requires for camping, cell selection, or cell reselection in the second cell, the second set comprising a subset of essential system information that is configured differently in the second cell than in the first cell.

In a particular embodiment, the first cell and the second cell are associated with a network node 110, and the set of system information parameters and the indication are received from the network node.

In a particular embodiment, the set of system information parameters is received from a first network node 110A associated with the first cell, and the indication is received from a second network node 110B associated with the second cell.

FIG. 12 illustrates an example method 800 performed by a network node 110A associated with a cell of a NTN, according to certain embodiments. At step 802, the network node 110A sends, to a UE 112, 200, an indication to use, in the cell, a set of one or more system information parameters previously received by the UE for use in another cell.

In a particular embodiment, based on the indication, the network node 110A determines not to send the set of one or more system information parameters to the UE.

In a particular embodiment, the set of one more system information parameters includes essential system information.

In a particular embodiment, the indication is sent in a broadcast message.

In a particular embodiment, the indication is sent in a MIB.

In a further particular embodiment, the MIB includes a H-SFN indicator.

In a further particular embodiment, the MIB does not include a H-SFN indicator, and the absence of the H-SFN indicator in the MIB indicates that the UE is to keep track of H-SFN cycles and/or acquire system information to confirm or update the H-SFN cycles.

In a particular embodiment, the one or more system information parameters comprises a signal strength threshold for determining whether the UE can camp in the second cell.

In a particular embodiment, the indication comprises a tracking area code of the cell of the network node that is the same as a tracking area code of the other cell.

In a particular embodiment, the indication comprises a system information area identifier of the cell of the network node that is the same as a system information area identifier of the other cell.

In a particular embodiment, the system information area identifier of the cell of the network node is sent in scheduling information associated with a SIB.

In a particular embodiment, the network node 110A sends, to the UE 112A, 200, a second set of one or more system information parameters for camping, cell selection, or cell reselection in the cell of the network node by the UE. The second set includes only a subset of essential system information that is configured differently in the cell of the network node than in the other cell.

In a particular embodiment, the other cell is another cell of the network node 110A.

In a particular embodiment, the other cell is a cell of a different network node 110B, and the first set of one or more system information parameters was received by the UE from the different network node.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Embodiments

Example Embodiment A1. A method performed by a wireless device (such as a user equipment), the method comprising: receiving, from a first cell of a non-terrestrial network, a set of one or more system information parameters that the wireless device requires for camping, cell selection, or cell reselection in the first cell; receiving, from a second cell of the non-terrestrial network, an indication that the second cell configures the same set of one or more system information parameters as the first cell for camping, cell selection, or cell reselection in the second cell; and using the set of one or more system information parameters received from the first cell for camping, cell selection, or cell reselection in the second cell.

Example Embodiment A2. The method of Example Embodiment A1, wherein the set of one more system information parameters comprises essential system information.

Example Embodiment A3. The method of any of Example Embodiments A1-A2, wherein the indication that the second cell configures the same set of one or more system information parameters as the first cell is received in a broadcast message.

Example Embodiment A4. The method of any of Example Embodiments A1-A3, wherein the indication that the second cell configures the same set of one or more system information parameters as the first cell is received in a Master Information Block (MIB).

Example Embodiment A5. The method of Example Embodiment A4, wherein the MIB comprises a hyper subframe number (H-SFN) indicator the absence or presence of which indicates whether the wireless device is to keep track of H-SFN cycles itself or is to acquire system information to confirm or update the H-SFN cycles.

Example Embodiment A6. The method of any of Example Embodiments A1-A5, wherein the indication that the second cell configures the same set of one or more system information parameters as the first cell comprises a tracking area code of the second cell that corresponds to a tracking area code of the first cell.

Example Embodiment A7. The method of any of Example Embodiments A1-A6, wherein the indication that the second cell configures the same set of one or more system information parameters as the first cell comprises a system information area identifier of the second cell that corresponds to a system information area identifier of the first cell.

Example Embodiment A8. The method of Example Embodiment A7, wherein the system information area identifier of the second cell is received in scheduling information associated with a system information block (SIB) (such as schedulingInfoSIB1-BR-r13).

Example Embodiment A9. The method of any of Example Embodiments A1-A8, wherein the wireless device is an IoT device, an MTC device, or a BL/CE UE.

Example Embodiment A10. The method of any of Example Embodiments A1-A9, wherein the wireless device abstains from acquiring the set of one or more system information parameters from the second cell based on the wireless having already received the set of one or more system information parameters from the first cell.

Example Embodiment A11. The method of any of Example Embodiments A1-A10, further comprising: receiving, from the second cell, a second set of one or more system information parameters that the wireless device requires for camping, cell selection, or cell reselection in the second cell, the second set comprising only a subset of essential system information that is configured differently in the second cell than in the first cell.

Example Embodiment A12. The method of any of the previous Example Embodiments, further comprising: providing user data; and forwarding the user data to a host via the transmission to the network node.

### Group B Embodiments

Example Embodiment B1. A method performed by a network node of a non-terrestrial network, the method comprising: sending a wireless device an indication indicating whether a cell of the network node configures a set of one or more system information parameters for camping, cell selection, or cell reselection that is the same as a set of one or more system information parameters for camping, cell selection, or cell reselection that the wireless device received from another cell.

Example Embodiment B2. The method of Example Embodiment B1, wherein the set of one more system information parameters comprises essential system information.

Example Embodiment B3. The method of any of Example Embodiments B1-B2, wherein the indication that the cell of the network node configures the same set of one or more system information parameters as another cell is sent in a broadcast message.

Example Embodiment B4. The method of any of Example Embodiments B1-B3, wherein the indication that the cell of the network node configures the same set of one or more system information parameters as another cell is sent in a Master Information Block (MIB).

Example Embodiment B5. The method of Example Embodiment B4, wherein the MIB comprises a hyper subframe number (H-SFN) indicator the absence or presence of which indicates whether the wireless device is to keep track of H-SFN cycles itself or is to acquire system information to confirm or update the H-SFN cycles.

Example Embodiment B6. The method of any of Example Embodiments B1-B5, wherein the indication that the cell of the network node configures the same set of one or more system information parameters as the other cell comprises a tracking area code of the cell of the network node that corresponds to a tracking area code of the other cell.

Example Embodiment B7. The method of any of Example Embodiments B1-B6, wherein the indication that the cell of the network node configures the same set of one or more system information parameters as the other cell comprises a system information area identifier of the cell of the network node that corresponds to a system information area identifier of the other cell.

Example Embodiment B8. The method of Example Embodiment B7, wherein the system information area identifier of the cell of the network node is sent in scheduling information associated with a system information block (SIB) (such as schedulingInfoSIB1-BR-r13).

Example Embodiment B9. The method of any of Example Embodiments B1-B8, wherein the wireless device is an IoT device, an MTC device, or a BL/CE UE.

Example Embodiment B10. The method of any of Example Embodiments B1-B9, wherein the indication enables the wireless device to abstain from acquiring the set of one or more system information parameters from the cell of the network node based on the wireless having already received the set of one or more system information parameters from the other cell.

Example Embodiment B11. The method of any of Example Embodiments B1-B10, further comprising: sending the wireless device a second set of one or more system information parameters that the wireless device requires for camping, cell selection, or cell reselection in the cell of the network node, the second set comprising only a subset of essential system information that is configured differently in the cell of the network node than in the other cell.

Example Embodiment B12. The method of any of Example Embodiments B1-B11, wherein the other cell is another cell of the network node.

B13. The method of any of Example Embodiments B1-B11, wherein the other cell is a cell of a different network node.

B14. The method of any of the previous embodiments, further comprising: obtaining user data; and forwarding the user data to a host or a user equipment.

### Group C Embodiments

Example Embodiment C1. A user equipment, comprising: processing circuitry configured to perform any of the steps of any of the Group A Example Embodiments; and power supply circuitry configured to supply power to the processing circuitry.

Example Embodiment C2. A network node, the network node comprising: processing circuitry configured to perform any of the steps of any of the Group B Example Embodiments; power supply circuitry configured to supply power to the processing circuitry.

Example Embodiment C3. A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment C4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment C5. The host of the previous embodiment, wherein the cellular network further includes a network node configured to communicate with the UE to transmit the user data to the UE from the host.

Example Embodiment C6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment C7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment C8. The method of the previous embodiment, further comprising: at the host, executing a host application associated with a client application executing on the UE to receive the user data from the UE.

Example Embodiment C9. The method of the previous embodiment, further comprising: at the host, transmitting input data to the client application executing on the UE, the input data being provided by executing the host application, wherein the user data is provided by the client application in response to the input data from the host application.

Example Embodiment C10.A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Example Embodiment C11. The host of the previous Example Embodiment, wherein the cellular network further includes a network node configured to communicate with the UE to transmit the user data from the UE to the host.

Example Embodiment C12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment C13.A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment C14. The method of the previous Example Embodiment, further comprising: at the host, executing a host application associated with a client application executing on the UE to receive the user data from the UE.

Example Embodiment C15. The method of the previous Example Embodiment, further comprising: at the host, transmitting input data to the client application executing on the UE, the input data being provided by executing the host application, wherein the user data is provided by the client application in response to the input data from the host application.

Example Embodiment C16.A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B Example Embodiments to transmit the user data from the host to the UE.

Example Embodiment C17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment C18.A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B Example Embodiments to transmit the user data from the host to the UE.

Example Embodiment C19. The method of the previous Example Embodiment, further comprising, at the network node, transmitting the user data provided by the host for the UE.

Example Embodiment C20. The method of any of the previous 2 Example Embodiments, wherein the user data is provided at the host by executing a host application that interacts with a client application executing on the UE, the client application being associated with the host application.

Example Embodiment C21.A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B Example Embodiments to transmit the user data from the host to the UE.

Example Embodiment C22. The communication system of the previous embodiment, further comprising: the network node; and/or the user equipment.

Example Embodiment C23.A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B Example Embodiments to receive the user data from a user equipment (UE) for the host.

Example Embodiment C24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment C25. The host of the any of the previous 2 Example Embodiments, wherein the initiating receipt of the user data comprises requesting the user data.

Example Embodiment C26.A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B Example Embodiments to receive the user data from the UE for the host.

Example Embodiment C27. The method of the previous embodiment, further comprising at the network node, transmitting the received user data to the host.

1. A method performed by a user equipment, UE, the method comprising:
receiving, from a first cell of a non-terrestrial network, NTN, a set of one or more system information parameters; and
receiving, from a second cell of the NTN, an indication to use, for the second cell, the set of one or more system information parameters received from the first cell.

2. The method of claim 1, comprising:
based on the indication, determining not to acquire the set of one or more system information parameters from the second cell based on the UE having received the set of one or more system information parameters from the first cell.

3. The method of claim 1, comprising:
based on the indication, using at least one parameter within the set of system information parameters received from the first cell to determine whether the UE can camp in the second cell.

4. The method of claim 3, wherein the at least one parameter comprises a threshold, and wherein determining whether the UE can camp in the second cell comprises determining that a signal strength in the second cell is greater than the threshold.

5. The method of claim 1, comprising:
based on the indication, using at least one parameter within the set of one or more system information parameters received from the first cell for performing an operation associated with at least one of camping, cell selection, and cell reselection in the second cell.

6. The method of claim 1, wherein the set of one more system information parameters comprises essential system information.

7. The method of claim 1, wherein the indication from the second cell is received in a broadcast message.

8. The method of claim 1, wherein the indication from the second cell is received in a Master Information Block, MIB.

9. The method of claim 8, wherein the MIB comprises a hyper subframe number, H-SFN, indicator.

10. The method of claim 8, comprising:
determining that the MIB does not include a hyper subframe number, H-SFN indicator; and
based on the MIB not including the H-SFN, keeping track of H-SFN cycles at the UE and/or acquiring system information to confirm or update the H-SFN cycles.

11. The method of claim 1, wherein the indication from the second cell comprises a tracking area code of the second cell that is the same as a tracking area code of the first cell.

12. The method of claim 1, wherein the indication from the second cell comprises a system information area identifier of the second cell that is the same as a system information area identifier of the first cell.

13. The method of claim 12, wherein the system information area identifier of the second cell is received in scheduling information associated with a system information block, SIB.

14. The method of claim 1, further comprising:
receiving, from the second cell, a second set of one or more system information parameters that the UE requires for camping, cell selection, or cell reselection in the second cell, the second set comprising a subset of essential system information that is configured differently in the second cell than in the first cell.

15. The method of claim 1, wherein the first cell and the second cell are associated with a network node, and the set of system information parameters and the indication are received from the network node.

16. The method of claim 1, wherein;
the set of system information parameters is received from a first network node associated with the first cell; and
the indication is received from a second network node associated with the second cell.

17. A method performed by a network node associated with a cell of a non-terrestrial network, NTN, the method comprising:
sending, to a user equipment, UE, an indication to use, in the cell, a set of one or more system information parameters previously received by the UE for use in another cell.

18. The method of claim 17, comprising:
based on the indication, determining not to send the set of one or more system information parameters to the UE.

19. The method of claim 17, wherein the set of one more system information parameters comprises essential system information.

20. The method of claim 17, wherein the is sent in a broadcast message.

21. The method of claim 17, wherein the indication is sent in a Master Information Block, MIB.

22. The method of claim 21, wherein the MIB comprises a hyper subframe number, H-SFN, indicator.

23. The method of claim 21, wherein the MIB does not include a hyper subframe number, H-SFN, indicator, and wherein the absence of the H-SFN indicator in the MIB indicates that the UE is to keep track of H-SFN cycles and/or acquire system information to confirm or update the H-SFN cycles.

24. The method of claim 17, wherein the one or more system information parameters comprises a signal strength threshold for determining whether the UE can camp in the second cell.

25.-30. (canceled)

31. A user equipment, UE, comprising:
processing circuitry configured to:
receive, from a first cell of a non-terrestrial network, NTN, a set of one or more system information parameters;
receive, from a second cell of the NTN, an indication to use, for the second cell, the set of one or more system information parameters received from the first cell.

32. (canceled)

33. A network node comprising:
processing circuitry configured to:
send, to a user equipment, UE, an indication to use, in the cell, a set of one or more system information parameters previously received by the UE for use in another cell.

34. (canceled)
